(19) United States
(12) Patent Application Publication
(10) Pub. No.: US 2026/0323800 A1
(43) Pub. Date: Oct. 15, 2026

(54) AN LED DRIVING CIRCUIT

(71) Applicant: SIGNIFYHOLDINGB.V., EINDHOVEN (NL)

(72) Inventors: ZHAOPENG HE, SHANGHAI (CN); HAIMIN TAO, EINDHOVEN (NL); GAOXIAN JIN, SHANGHAI (CN); FAN ZHENG, SHANGHAI (CN); XIAOLIN CHEN, SHANGHAI (CN); DEYONG KONG, SHANGHAI (CN); HE ZHAO, SHANGHAI (CN)

(21) Appl. No.: 19/482,866

(22) PCT Filed: Apr. 23, 2024
(86) PCT No.: PCT/EP2024/061075

§ 371 Date: Nov. 10, 2025

(30) Foreign Application Priority Data
May 10, 2023 (WO) PCT/CN2023/093293
Jul. 13, 2023 (EP) 23185212.0

(51) Int. Cl. H05B 45/50

(52) U.S. Cl. CPC H05B 45/50

(57) ABSTRACT

An LED driving circuit for powering a tubular LED. The LED driving circuit comprises a voltage multiplying circuit that is only enabled when an input interface of the LED driving circuit receives an AC power signal from a high frequency ballast. The voltage multiplying circuit is disabled or bypassed when the LED driving circuit receives an AC power signal from an electromagnetic ballast or a main supply.

### FIELD OF THE INVENTION

The present invention relates to the field of LED lighting, and in particular to LED lighting devices.

### BACKGROUND OF THE INVENTION

The increasing use of artificial light is causing a greater demand for LED lighting devices, which typically comprise an LED driving circuit and an LED lighting arrangement driven by the LED driving circuit. An example of an LED lighting arrangement is a tubular LED (TLED) for replacing a fluorescent gas discharge lamp.

One form of LED lighting device comprising a tubular LED (TLED) is labelled a universal TLED device. A universal TLED device is able to adapt its operation so that it is able to be variously powered directly by a mains power supply, by an electromagnetic (EM) ballast or a high frequency (HF) ballast. A HF ballast is sometimes called an electronic ballast, which is designed for use with fluorescent lamps. Typically, a HF ballast outputs power having a frequency >10 kHz (e.g., >20 kHz), which differs from the much lower frequency (<1 kHz) of power provided by a mains power supply or an EM ballast.

More particular, the universal TLED device will selectively connect and disconnect one or more (input) pins dependent upon whether a mains power supply, an EM ballast or an HF ballast powers the universal TLED device.

A typical LED driving circuit for a tubular LED will comprise a switched-mode power supply (e.g., a buck converter) that is controlled to be active only when the input power is provided from a main supply or EM ballast, and not when provided from an HF ballast. This typically requires the use of a bypass switch (to selectively bypass the switched-mode power supply).

There is an ongoing desire to improve the efficiency, reduce the use of materially expensive components and increase an ease of manufacturability of an LED lighting device.

### SUMMARY OF THE INVENTION

The invention is defined by the claims.

According to examples in accordance with an aspect of the invention, there is provided an LED lighting device.

The LED lighting device comprises:
an input interface comprising a first set of pins and a second set of pins, wherein only the first set of pins receive an AC power signal when the input interface receives an AC power signal from the electromagnetic ballast or mains power supply, at which time the voltage difference between the first set of pins defines the AC power signal and wherein both the first set of pins and the second set of pins receive the AC power signal when the input interface receives the AC power signal from the high frequency ballast and the voltage difference between the first and second sets of pins defines the AC power signal;
an output interface for providing a DC power signal for driving the LED lighting arrangement;
a rectifier connected between the input interface and the output interface and configured to perform rectification of the AC power signal to produce the DC power signal;
the LED lighting arrangement comprising a series combination of a first LED and second LED;
a voltage multiplying circuit comprising a series combination of a first capacitor and a second capacitor, wherein the first capacitor is coupled in parallel with the first LED and the second capacitor is coupled in parallel with the second capacitor and configured to, when enabled, increase a voltage of the DC power signal at the output interface, wherein the rectifier is configured and positioned such that, when the voltage multiplying circuit is enabled:
power in a first half-cycle of the AC power signal charges the first capacitor; and
power in a second, different half-cycle of the AC power signal charges the second capacitor; and
a switched-mode power supply having an input connected between the first set of and an output at the output interface and configured to perform power conversion for the DC power signal at the output interface,
wherein the LED lighting device is configured such that the voltage multiplying circuit is enabled when the input interface receives the AC power signal from a high frequency ballast and is disabled when the input interface receives the AC power signal from an electromagnetic ballast or mains power supply.

Proposed approaches thereby provide an LED lighting device that can switch between two modes of operation. One mode of operation is suited for use when the AC power signal is provided by a high frequency ballast, with the other being suited for use when the AC power signal is provided by a mains supply or an electromagnetic ballast.

In particular, embodiments make use of a selectively enablable voltage multiplying circuit. The voltage multiplying circuit is enabled, or made active, when the AC power signal is to come from a high frequency ballast.

This use of a voltage multiplying circuit means that a DC power signal of a higher voltage (compared to existing approaches) is provided to the tubular LED lighting arrangement when the high frequency ballast is used. This means that a tubular LED lighting arrangement with a higher voltage rating and lower current can be used. In turn, this means that, if a bypass switch is used, a less materially expensive bypass switch can be used.

In some examples, the switched-mode power supply is disabled when the input interface receives the AC power signal from a high frequency ballast and is enabled when the input interface receives the AC power signal from an electromagnetic ballast or mains power supply. This is beneficial for improved efficiency and size (i.e. a more compact size) of the switched-mode power supply since it only needs to be dimensioned for operation with an AC power signal provided a mains power supply or an electromagnetic ballast (which typically provides an AC power signal with a voltage level similar to the mains power supply). When power is provided from a high frequency ballast, the voltage of the AC power signal is (much) lower and the current is higher. The switched-mode power supply may, according to proposed approaches, be bypassed or disabled in this situation, allowing the current from the high frequency ballast to be directly rectified and supplied to the LED load. This is made possible by the fact that the high frequency ballast outputs a current, instead of a voltage, and the LEDs requires a constant current to operate.

The voltage multiplying circuit may be a voltage doubling circuit. This provides a low cost and space efficient multiplying circuit.

The rectifier and voltage multiplying circuit are combined in the form of a full wave series multiplier connected to the input interface. This provides a highly materially and space efficient LED lighting device.

In some examples, the input interface comprises a first set of pins and a second set of one or more pins; only the first set of pins receive the AC power signal when the input interface receives the AC power signal from the electromagnetic ballast or mains power supply, at which time the voltage difference between two of the first set of pins defines the AC power signal; and both the first set of pins and the second set of one or more pins receive the AC power signal when the input interface receives the AC power signal from the high frequency ballast, at which time the voltage at different ones of the first set of pins is substantially (i.e., approximately) the same and the voltage difference between the first and second sets of pins defines the AC power signal.

There may be a minor voltage difference between the different ones of the first set of pins depending on ballast type, e.g., due to a filament heating voltage (which is usually around 3V). However, the voltages are considered to be substantially the same as they do not differ by a significant amount (e.g., <10% or <5%).

The LED lighting device may comprise a switch arrangement configured to connect the second set of one or more pins to the voltage multiplying circuit when the input interface receives the AC power signal from the high frequency ballast; and disconnect the second set of one or more pins from the voltage multiplying circuit when the input interface receives the AC power signal from the electromagnetic ballast or mains power supply.

In some examples, the voltage multiplying circuit comprises a first capacitor and a second capacitor connected in series, each capacitor having a first and second plate; the rectifier is configured and positioned such that, when the voltage multiplying circuit is enabled: power in a first half-cycle of the AC power signal charges the first capacitor; and power in a second, different half-cycle of the AC power signal charges the second capacitor.

In some examples, the rectifier comprises a first diode having an anode connected to one of the first set of pins and a cathode connected to the first plate of the first capacitor; the second plate of the first capacitor is connected to the first plate of the second capacitor; the rectifier comprises a second diode having an anode connected to the second plate of the second capacitor and a cathode connected to the one of the first set of pins; and the second set of one or more pins is connected, when the input interface receives the AC power signal from the high frequency ballast, to the second plate of the first capacitor.

The LED lighting device may be adapted wherein: the rectifier voltage multiplying circuit comprises a third diode having an anode connected, when the input interface receives the AC power signal from a high frequency ballast, to the second set of one or more pins and a cathode connected to the first plate of the first capacitor; the second plate of the first capacitor is connected to the first plate of the second capacitor; the rectifier comprises a fourth diode having a cathode connected, when the input interface receives the AC power signal from a high frequency ballast, to the second set of one or more pins and an anode connected to the second plate of the second capacitor; and the rectifier comprising a diode arrangement having cathode end connected to the first set of pins and to the second plate of the first capacitor.

The second plate of the first capacitor and the first plate of the second capacitor may be connected to a tap for the LED lighting arrangement. This provides a DC path for the first and second capacitors, e.g., to allow for a DC path through the voltage multiplier since a DC current cannot flow through these capacitors. Some high frequency ballasts output a high frequency current with a small DC offset. A provision for this DC current therefore improves compatibility with the high frequency ballast.

The LED lighting device may further comprise a bypass circuit configured to: bypass the switched-mode power supply when the input interface receives the AC power signal from a high frequency ballast; and stop bypassing the switched-mode power supply when the input interface receives the AC power signal from an electromagnetic ballast or mains power supply.

The bypass circuit may be connected between the output interface and the voltage multiplying circuit or rectifier. The bypass circuit may controllably connect a return line of the LED lighting arrangement (as defined by the output interface) to a return line of the switched-mode power supply or rectifier.

The bypass circuit may comprise a thyristor. This provides a low cost and materially/space efficient bypass circuit.

In some examples, the switched-mode power supply is a buck converter. However, other forms and configurations for a switched-mode power supply could be used, depending upon specific implementation desires.

There is also provided an LED lighting device comprising any herein disclosed LED lighting device; and a tubular LED lighting arrangement. The tubular LED lighting arrangement may comprise a plurality of LEDs connected in series.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 schematically illustrates a proposed LED lighting device;

FIG. 2 is a circuit diagram illustrating a proposed LED lighting device;

FIG. 3 is a circuit diagram illustrating another proposed LED lighting device; and

FIG. 4 is a circuit diagram illustrating yet another proposed LED lighting device.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an LED lighting device for powering a tubular LED. The LED lighting device comprises a voltage multiplying circuit that is only enabled when an input interface of the LED lighting device receives an AC power signal from a high frequency ballast. The voltage multiplying circuit is disabled or bypassed when the LED lighting device receives an AC power signal from an electromagnetic ballast or a main supply.

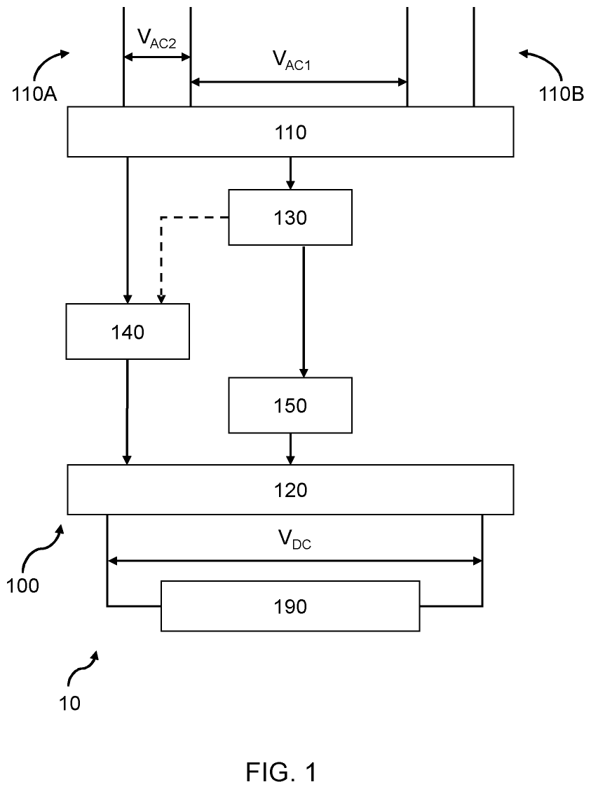

FIG. 1 schematically illustrates an LED lighting device 100 for driving a tubular LED lighting arrangement 190. This is for the purposes of improved contextual understanding. The LED lighting device 100 and tubular LED lighting arrangement 190 together form an LED lighting device 10.

The LED lighting device comprises an input interface 110 configured to receive an AC power signal V_{AC1}, V_{AC2} and an output interface 120 for providing a DC power signal VDc for driving the LED lighting arrangement.

The input interface 110 may be configurable to receive (at least) two different types of AC power signal V_{AC1}, V_{AC2}. A first AC power signal V_{AC1} may be a power signal from a high frequency ballast. A second AC power signal V_{AC2} may be an AC power signal from an electromagnetic ballast or mains power supply.

In particular, the input interface may receive the first AC power signal between a first set of pins and the second AC power between a second, different set of pins. This configuration and arrangement is well established in the field of a universal TLED device previously mentioned.

In general, an individual or installer of such a LED device is able to indicate or otherwise identify which form of power supply or ballast is used to power the TLED. The operation of the LED lighting device is dependent upon which form of power supply or ballast is connected, as later described.

The LED lighting device 100 also comprises a rectifier 130 connected between the input interface and the output interface and configured to perform rectification of the AC power signal to produce the DC power signal. As illustrated, the rectifier may be directly connected to the input interface 110 for rectifying the AC power signal provided at the input interface.

The LED lighting device 100 also comprises a voltage multiplying circuit 140 connected between the input interface and the output interface. The voltage multiplying circuit is configured to, when enabled, increase a voltage of the DC power signal at the output interface. This is performed using a voltage multiplying process, examples of which are well known in the art.

It will therefore be apparent that the voltage multiplying circuit can be enabled and/or disabled based on whether the first or second AC power signals is received by the input interface. This can be controlled, for instance, through appropriate wired connections and/or arrangement(s) of the voltage multiplying circuit and any input pins of the input interface. Examples of possible approaches are later described.

More particularly, the LED lighting device 100 is configured such that the voltage multiplying circuit 140 is enabled when the input interface 110 receives the AC power signal V_{AC1} from a high frequency ballast and is disabled when the input interface receives the AC power signal V_{AC2} from an electromagnetic ballast or mains power supply.

The LED lighting device 100 also comprises a switched-mode power supply 150 connected between the input interface and the output interface. The switched-mode power supply is configured to perform power conversion for the DC power signal at the output interface.

As illustrated, the switched-mode power supply 150 may perform power conversion on a signal output by the rectifier 130 circuit. Thus, the input voltage to the switched-mode power supply may be a rectified version of the AC power signal V_{AC2} received at the input interface 110.

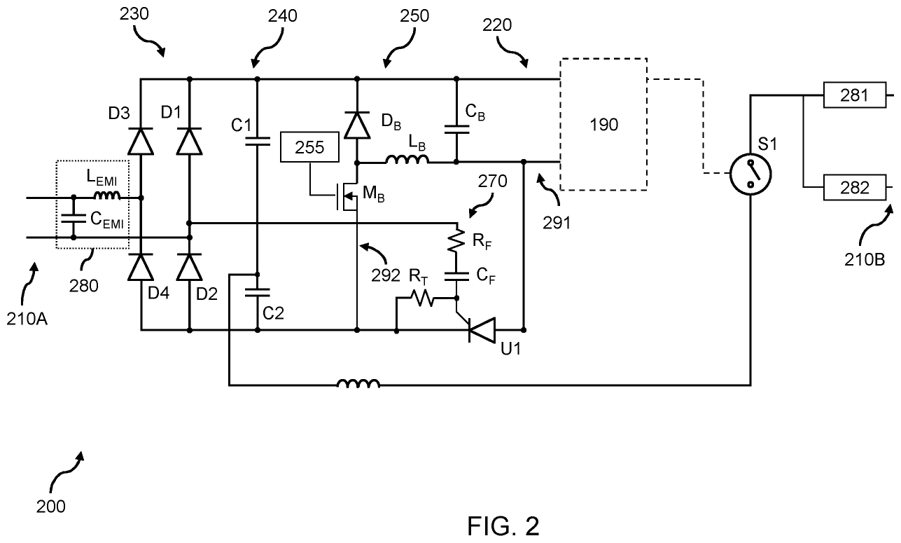

Examples of tubular LED lighting arrangements 190 are well known in the art, and typically comprise one or more light emitting diodes arranged linearly and/or in a string. FIG. 2 is a circuit diagram illustrating an example LED driving circuit 200 according to an embodiment.

The LED driving circuit comprises an input interface 210A, 210B, an output interface 220, a rectifier 230, a voltage multiplying circuit 240 and a switched-mode power supply 250.

The input interface 210 comprises a first set of pins 210A (comprising a pair of pins) and a second set 210B of one or more pins (here comprising a pair of pins, but optionally instead comprising only a single pin).

Only the first set of pins receive the AC power signal when the input interface receives the AC power signal from the electromagnetic ballast or mains power supply, at which time the voltage difference between two of the first set of pins defines the AC power signal. Thus, the voltage difference between the pair of pins in the first set of pins may here define the AC power signal.

Both the first set of pins and the second set of one or more pins receive the AC power signal when the input interface receives the AC power signal from the high frequency ballast, at which time the voltage at different ones of the first set of pins is the same and the voltage difference between the first and second sets of pins defines the AC power signal. During this time, there is no or negligible voltage difference (e.g., only the filament heating voltage, if generated by the high frequency ballast) between any of the pins in the first set of pins. Similarly, during this time, there is no or negligible voltage difference between any of the pins in the second set of pins (if the second set of pins comprises more than one pin).

The LED driving circuit 200 is thereby effectively operable in two separate modes. Switching between operating in the first mode and operating in the second mode can be controlled by changing the conductivity of a switch arrangement S1, which is preferably a relay.

The control of the switch arrangement S1 can be performed by a (human) individual or automatically, e.g., by a separate circuit configured to detect whether or not the AC input supply is from a high frequency ballast or a mains supply or electromagnetic ballast.

In a first mode, the LED driving circuit receives the AC power only at the first set of pins 210A. In this first mode, the second set of pins 210B may be electrically disconnected from the remainder of the LED driving circuit by the switch arrangement S1. The LED driving circuit can be controlled to operate in the first mode when the input interface receives the AC power signal from the electromagnetic ballast or mains power supply. As such, the first mode can be labelled as “mains power mode” or “electromagnetic ballast power mode”.

In a second mode, the LED driving circuit receives the AC power between the first 210A and second 210B sets of pins. In this second mode, the second set of pins 210B is electrically connected to the remainder of the LED driving circuit, e.g., by switch arrangement S1. The LED driving circuit can be controlled to operate in the second mode when the input interface receives the AC power signal from the high frequency ballast. As such, the second mode can be labelled as “high frequency mode” or “HF ballast mode”.

The above described operation of an input interface, and separate modes of an LED driving circuit, follows well established protocols and procedures in the art for handling the driving of a tubular LED lighting arrangement powered by different forms of power source or supplies.

The underlying approach proposed by the present disclosure relates to the internal configuration of the LED driving circuit that is adapted depending upon in which mode the LED driving circuit is controlled to operate.

The rectifier 230 here comprises a bridge rectifier D1, D2, D3, D4.

The voltage multiplying circuit 240 here comprises a voltage doubling circuit.

In particular, the voltage multiplying circuit 240 is configured in the form of a full wave series multiplier. In this approach, the rectifier contributes to the voltage multiplying circuit. The basic principle of such full wave series multipliers is well known, e.g., as set out by Beck, Joseph M. “Using rectifiers in voltage multiplier circuits.” General Semiconductor 14 (2001).

More specifically, the voltage multiplying circuit 240 comprises a first capacitor C1 and a second capacitor C2 connected in series. Each capacitor C1, C2 has a first and second plate. The rectifier 230 is configured and positioned such that, when the voltage multiplying circuit is enabled: power in a first half-cycle of the AC power signal charges the first capacitor C1; and power in a second, different half-cycle of the AC power signal charges the second capacitor C2.

In the illustrated example, this is achieved by the rectifier 230 comprising a first diode DI having an anode connected to one of the first set of pins and a cathode connected to the first plate of the first capacitor C1. The second plate of the first capacitor C1 is connected to the first plate of the second capacitor C2.

The rectifier 230 also comprises a second diode D2 having an anode connected to the second plate of the second capacitor C2 and a cathode connected to the one of the first set 210A of pins. The second set 210B of one or more pins is connected, when the input interface receives the AC power signal from the high frequency ballast to the second plate of the first capacitor C1.

In this way, when operating in the second mode (i.e., when the switch arrangement S1 connects the second set of pins to the remainder of the LED driving circuit), voltage doubling of the AC input voltage from the high frequency ballast takes place. The combination of the rectifier 230 and the voltage multiplying circuit 240 also act to perform AC-DC conversion.

When operating in the first mode, the capacitors C1, C2 of the voltage multiplying circuit 240 act as a (single) smoothing capacitor for the AC power signal after being rectified by the bridge rectifier D1, D2, D3, D4. The bridge rectifier 230 here operates in a conventional way to perform full wave rectification of an AC input signal provided across the first pins 210A of the input interface, which rectified signal is provided to the capacitors C1, C2.

In this way, when operating in the first mode, the voltage multiplying circuit 240 is inactive, in that no voltage multiplication of the AC power signal takes place. Rather, the capacitors C1, C2 of the voltage multiplying circuit are repurposed for performing a smoothing function of a rectified version of the AC power signal provided at the first set of pins.

The LED driving circuit 200 also comprises a switched-mode power supply 250.

The switched mode power supply is operable to perform voltage conversion of a voltage provided across the rectifier circuit. When the LED driving circuit 200 operates in the first mode, this voltage is the rectified version of the AC power signal (as the capacitors of the voltage multiplying circuit operate as a smoothing capacitor). When the LED driving circuit 200 operates in the second mode, this voltage is the rectified and multiplied version of the AC power signal.

The illustrated switched-mode power supply 250 is in the form of a buck converter, thereby comprising a buck diode D_{B}, a buck inductor L_{B}, a buck capacitor C_{B} and a buck switch M_{B} (e.g., a MOSFET). The operation of a buck converter is well known and comprises performing appropriate control of the switching by the buck switch M_{B} in order to control a magnitude of a voltage provided at the output of the buck converter. Thus, the buck converter may correspondingly comprise control logic 255 for controlling the conductivity of the buck switch.

However, the buck converter forming the switched-mode power supply 250 may be replaced by any other form of switched-mode power supply, such as another buck converter (i.e., a buck converter having a different configuration), a boost converter, a buck-boost converter or a flyback converter. Appropriate arrangements for such forms of switched-mode power supplies are well known in the art.

Further optional features of the LED driving circuit 200 are hereafter described.

The LED driving circuit may comprise a bypass circuit 270.

The bypass circuit 270 is configured to: bypass the switched-mode power supply 250 when the input interface receives the AC power signal from a high frequency ballast; and stop bypassing the switched-mode power supply 250 when the input interface receives the AC power signal from an electromagnetic ballast or mains power supply,

Thus, the bypass circuit 270 is configured to bypass or disable the switched-mode power supply 250 when the LED driving circuit operates in the second mode. The bypass circuit 270 does not bypass or disable the switched-mode power supply when the LED driving circuit operates in the first mode.

More particularly, the illustrated bypass circuit 270 is configured to connect a return line 291 (e.g., minus node) for the LED lighting arrangement with a return line 292 of the switched-mode power supply. The return line provides the return path for power flow through or across the relevant component, e.g., representing a ground or the like.

The bypass circuit 270 may comprise a switch U1 that is controlled to be conductive when power is received from a high frequency ballast.

Detecting the occurrence of receiving power from a high frequency ballast can be achieved using an RC (i.e., high pass) filter connected to a midpoint of the rectifier 230 (particularly, a midpoint of a part of the rectifier that is active during the second mode of operation when rectifying an AC power signal received from a high frequency ballast). The RC filter will only pass a signal for activating the switch U1 when a high frequency signal is present at the midpoint of the rectifier. Thus, in EM/Mains mode, the switch remains off and the switched-mode power supply is not bypassed (i.e., remains enabled).

The switch U1 may comprise a thyristor, for improved material efficiency and device compactness. Thus, the RC filter may connect between a midpoint of the rectifier 230 and the gate of the thyristor.

A further resistor R_{T} is connected between the gate of the thyristor (or gate/base of another form of switch) and the cathode of the thyristor (or emitter/drain of another form of switch). The further resistor R_{T} reduces the likelihood of a mis-trigger of the switch U1.

The LED driving circuit may comprise an EMI filter 280.

The EMI filter is configured to perform EMI filtering on an AC input signal provided to the first set of pins, the function of which is well known in the art. The EMI filter here comprises an EMI inductor L_{EMI} (connected between one of the first set of pins and the rectifier 230) and an EMI capacitor C_{EMI} (connected between the first set of pins).

When such an EMI filter is present, the anode of the first diode is preferably connected to the pin (of the first set of pins) that is not directly connected to the EMI inductor L_{EMI}. This is because a high frequency signal will be blocked by the EMI inductor.

Similarly, when such an EMI filter 280 is present, it will be appreciated that one half D3, D4 of the rectifier effectively becomes inactive during the second mode of operation of the LED driving circuit (when the AC power signal is received from a high frequency ballast). This is again because such a high frequency signal will be blocked by the EMI inductor.

The LED driving circuit may further comprise, for each pin of the second set 210B of pins, a filament impedance circuit 281, 282. The filament impedance circuit may comprise, for instance, a resistor and capacitor connected in parallel.

Although not illustrated, in some examples, the LED driving circuit 200 is configured such that the second plate of the first capacitor C1 and the first plate of the second capacitor C2 connects to a (center) tap of the tubular LED lighting arrangement 190. In particular, the tubular LED lighting arrangement may comprise a plurality of LEDs connected in series, with a center tap connected in between a first and second set of one or more LEDs (of the plurality of LEDs).

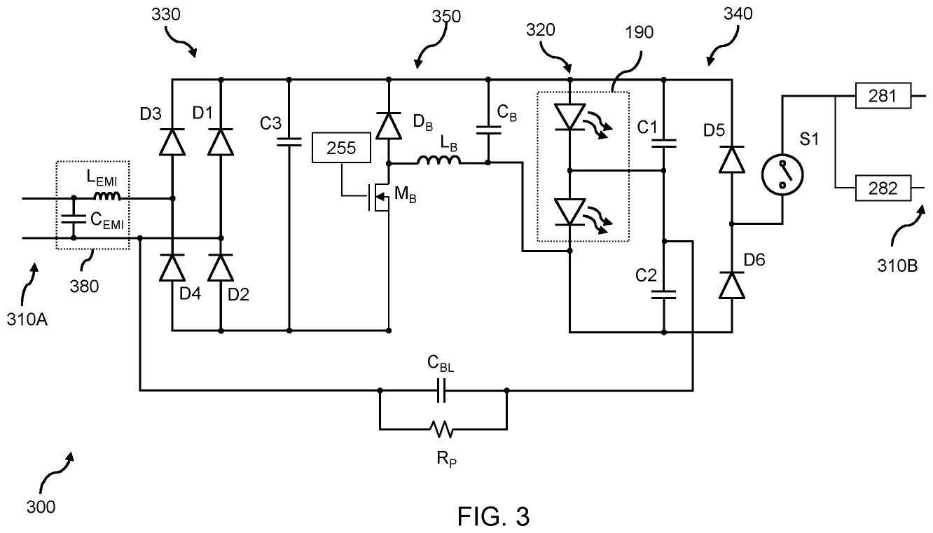

FIG. 3 is a circuit diagram illustrating another example LED driving circuit 300 according to an embodiment.

The LED driving circuit 300 comprises an input interface 310A, 310B, an output interface 320, a rectifier 330, D5, D6 a voltage multiplying circuit 340 and a switched-mode power supply 350.

The configuration and operation of the input interface 310A, 310B is the same as the previous embodiment, and is not repeated for the sake of conciseness.

In this approach, the rectifier 330, D5, D6 for rectifying an AC power signal from a high frequency ballast is separated from the rectifier for rectifying an AC power signal from an electromagnetic ballast or mains power supply.

As before, the voltage multiplying circuit 340 comprises a first capacitor C1 and a second capacitor C2.

The rectifier 330, D5, D6 comprises a third diode D5 having an anode connected, when the input interface 310A, 310B receives the AC power signal from a high frequency ballast, to the second set 310B of one or more pins and a cathode connected to the first plate of the first capacitor C1. The second plate of the first capacitor C1 is connected to the first plate of the second capacitor C2.

The rectifier 330, D5, D6 also comprises a fourth diode D6 having a cathode connected, when the input interface receives the AC power signal from a high frequency ballast, to the second set 310B of one or more pins and an anode connected to the second plate of the second capacitor C2.

The rectifier also comprises a diode arrangement D1, D3 having an anode end connected to the first set of pins and to the second plate of the first capacitor. The anode end is connected to the second plate of the first capacitor via a blocking capacitor C_{BL}, to prevent any temporary short circuit. The anode end of the diode arrangement is connected to the switched-mode power supply.

The rectifier also comprises a further diode arrangement D2, D4 having a cathode end connected to the first set of pins and to the second plate of the first capacitor. More particularly, the cathode end of the further diode arrangement D2, D4 is connected to the anode end of the diode arrangement D1, D3. The anode end of the further diode arrangement may be connected to a return line or path of the switched-mode power supply.

The configuration of the rectifier and voltage multiplying circuit means that the voltage multiplying circuit is only active or enabled when the second set of one or more pins receives the AC power signal (from the high frequency ballast). More particularly, the voltage multiplying circuit acts as a voltage doubling circuit.

The LED driving circuit 300 may comprise a smoothing capacitor C3 configured to smooth an output of the diode arrangement. The smoothing capacitor acts to smooth a rectified version of the AC power signal when it is provided from the first set of pins 310A of the input interface only, i.e., when the AC power signal is provided from a mains supply or electromagnetic ballast.

In some examples, the LED driving circuit is configured such that the second plate of the first capacitor C1 and the first plate of the second capacitor connects to a (center) tap of the tubular LED lighting arrangement 190. In particular, the tubular LED lighting arrangement may comprise a plurality of LEDs connected in series, with a center tap connected in between a first and second set of one or more LEDs (of the plurality of LEDs).

This center tap provides a DC path for the capacitors C1 and C2, e.g., to allow for a DC path for the capacitors C1 and C2, e.g., to allow for a DC path through the voltage multiplier since a DC current cannot flow through the capacitor C1 and C2. Some high frequency ballasts output a high frequency current with a small DC offset. A provision for this DC current improves compatibility with the high frequency ballast.

An alternative to a center tap is the provision of a resistor connected in parallel to each capacitor C1, C2.

Similarly, a DC path resistor R_{P} may be connected in series with the blocking capacitor to provide a DC path for the high frequency ballast (when it provides power to the LED driving circuit). If the AC power signal is provided by a mains supply, then the DC path resistor R_{P} may need to handle a high voltage. Accordingly, it would be advantageous (for improved safety) to make use of a power resistor, a PTC, or a fuse as the DC path resistor R_{P}.

Although not illustrated, the LED driving circuit may comprise a bypass circuit configured to selectively bypass the switched-mode power supply.

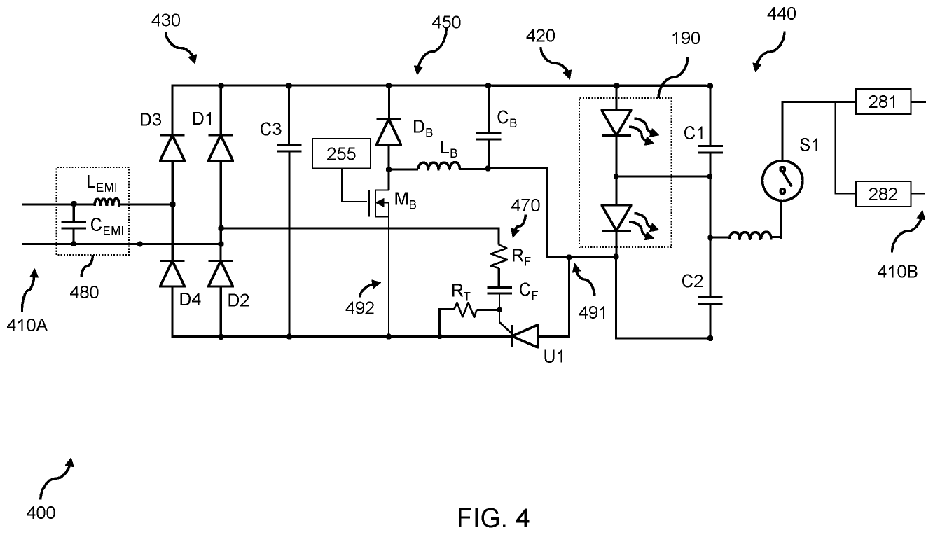

FIG. 4 is a circuit diagram illustrating another example LED driving circuit 400 according to an embodiment.

The LED driving circuit 400 comprises an input interface 410A, 410B, an output interface 420, a rectifier 430, D5, D6 a voltage multiplying circuit 440 and a switched-mode power supply 450.

The configuration and operation of the input interface 410A, 410B is the same as the previous embodiments, and is not repeated for the sake of conciseness.

In this approach, the rectifier 430 for rectifying an AC power signal from a high frequency ballast is again integrated into the rectifier for rectifying an AC power signal from an electromagnetic ballast or mains power supply.

As before, the voltage multiplying circuit 440 comprises a first capacitor C1 and a second capacitor C2. The voltage multiplying circuit is positioned on a side with the second set 410B of pins of the input interface.

The LED driving circuit again comprises a bypass circuit 470, which operates on the same principle as the previously described bypass circuit. In particular, the bypass circuit selectively connects a return line 491 of the LED lighting arrangement 190 with a return line 492 of the switched-mode power supply 450.

The LED driving circuit 400 differs from a previously described LED driving circuit 200 mainly in the positioning of the voltage multiplying circuit 440 and the presence of a connection between a center tap for the LED lighting arrangement 190 and the voltage multiplying circuit.

More particularly, the LED driving circuit 400 is configured such that the second plate of the first capacitor C1 and the first plate of the second capacitor connects to a (center) tap of the tubular LED lighting arrangement 190. In particular, the tubular LED lighting arrangement may comprise a plurality of LEDs connected in series, with a center tap connected in between a first and second set of one or more LEDs (of the plurality of LEDs). As previously explained, this center tap provides a DC path for the capacitors C1 and C2, e.g., to allow for a DC path through the voltage multiplier since a DC current cannot flow through the capacitor C1 and C2. Some high frequency ballasts output a high frequency current with a small DC offset. A provision for this DC current improves compatibility with the high frequency ballast.

An alternative to a center tap is the provision of a resistor connected in parallel to each capacitor C1, C2.

It will be appreciated that there is also proposed an LED lighting device comprising any herein or hereabove disclosed LED driving circuit and a tubular LED lighting arrangement (drawing power from the output interface of the LED driving circuit).

The tubular LED lighting arrangement may be configured as any known combination of LEDs for forming a tubular LED lighting arrangement, including a plurality of LEDs connected in series. Where relevant, the tubular LED lighting arrangement may comprise a tap (e.g., a center tap) for connection to the LED driving circuit.

For the sake of clarity, other potential features of the LED lighting device are not illustrated or described in detail, as they do not relate to the underlying inventive concept. These potential features include: control circuitry, communication circuitry, device housing(s), mounting mechanism, sensing arrangements, other electronic/electrical interconnects, light/color filters and so on. The skilled person would be readily capable of including such elements in an LED lighting device.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. An LED lighting device comprising:
an input interface comprising a first set of pins and a second set of pins, wherein only the first set of pins receive an AC power signal when the input interface receives an AC power signal from an electromagnetic ballast or mains power supply, at which time the voltage difference between the first set of pins defines the AC power signal and wherein both the first set of pins and the second set of pins receive the AC power signal when the input interface receives the AC power signal from a high frequency ballast and the voltage difference between the first and second sets of pins defines the AC power signal;
an LED lighting arrangement comprising a series combination of a first LED and a second LED;
an output interface for providing a DC power signal for driving the LED lighting arrangement;
a rectifier connected between the input interface and the output interface and configured to perform rectification of the AC power signal to produce the DC power signal;
a voltage multiplying circuit comprising a series combination of a first capacitor and a second capacitor, wherein the first capacitor is coupled in parallel with the first LED and the second capacitor is coupled in parallel with the second LED and configured to, when enabled, increase a voltage of the DC power signal at the output interface,
wherein the rectifier is configured and positioned such that, when the voltage multiplying circuit is enabled:
power in a first half-cycle of the AC power signal charges the first capacitor; and
power in a second, different half-cycle of the AC power signal charges the second capacitor; and
a switched-mode power supply having an input connected between the first set of pins and an output at the output interface and configured to perform power conversion for the DC power signal at the output interface,
wherein the LED lighting device is configured such that the voltage multiplying circuit is enabled when the input interface receives the AC power signal from the high frequency ballast and is disabled when the input interface receives the AC power signal from the electromagnetic ballast or mains power supply.

2. The LED lighting device of claim 1, wherein switched-mode power supply is disabled when the input interface receives the AC power signal from a high frequency ballast and is enabled when the input interface receives the AC power signal from an electromagnetic ballast or mains power supply.

3. The LED lighting device of claim 1, wherein the voltage multiplying circuit is a voltage doubling circuit.

4. The LED lighting device of claim 1, wherein the rectifier and voltage multiplying circuit are combined in the form of a full wave series multiplier connected to the input interface.

5. The LED lighting device of claim 1, further comprising a switch arrangement configured to:
connect the second set of one or more pins to the voltage multiplying circuit when the input interface receives the AC power signal from the high frequency ballast; and
disconnect the second set of one or more pins from the voltage multiplying circuit when the input interface receives the AC power signal from the electromagnetic ballast or mains power supply.

6. The LED lighting device of claim 1, wherein:
the rectifier comprises a first diode having an anode connected to one of the first set of pins and a cathode connected to the first plate of the first capacitor;
the rectifier comprises a second diode having an anode connected to the second plate of the second capacitor and a cathode connected to the one of the first set of pins; and
the second set of one or more pins is connected, when the input interface receives the AC power signal from the high frequency ballast, to the second plate of the first capacitor.

7. The LED lighting device of claim 1, wherein:
the voltage multiplying circuit comprises a third diode having an anode connected, when the input interface receives the AC power signal from a high frequency ballast, to the second set of one or more pins and a cathode connected to the first capacitor;
the rectifier comprises a fourth diode having a cathode connected, when the input interface receives the AC power signal from a high frequency ballast, to the second set of pins and a anode connected to the second capacitor; and
the rectifier comprising a diode arrangement having a cathode end connected to the first set of pins and to the first capacitor.

8. The LED lighting device of claim 1, further comprising a bypass circuit configured to:
bypass the switched-mode power supply when the input interface receives the AC power signal from a high frequency ballast; and
stop bypassing the switched-mode power supply when the input interface receives the AC power signal from an electromagnetic ballast or mains power supply.

9. The LED lighting device of claim 8, wherein the bypass circuit is configured to controllably connect a return line of the LED lighting arrangement to a return line of the switched-mode power supply when bypassing the switched-mode power supply.

10. The LED lighting device of claim 8, wherein the bypass circuit comprises a thyristor.
